(19) United States
(12) Patent Application Publication
(10) Pub. No.: US 2012/0251267 A1
(43) Pub. Date: Oct. 4, 2012

(54) PIN JOINT ASSEMBLY

(76) Inventors: Sarita Kuppili, Peoria, IL (US); Ronald M. Ginn, Morton, IL (US)

(21) Appl. No.: 13/385,586

(22) Filed: Feb. 16, 2010

(51) Int. Cl. F16B 19/02; F16B 35/00

(52) U.S. Cl. 411/378; 411/500

(57) ABSTRACT

A pin joint assembly is disclosed that includes a pin, a collar configured to engage the pin, and a plate defining holes through which the plate may be fastened to the collar and to a frame of a machine on which the assembly is mounted.

### CROSS-REFERENCE TO RELATED APPLICATIONS

This application claims the benefit of the filing date of, and for all other purposes claims priority to, U.S. Provisional Patent Application Ser. No. 61/152,842, filed in the U.S. Patent & Trademark Office on Feb. 16, 2009 and titled “PIN JOINT”.

### TECHNICAL FIELD

The invention described herein relates to pin joint assemblies, including pin joint assemblies utilized in axle assemblies of machines.

### BACKGROUND

An axle may sustain multiple loads during use, some of sufficient intensity to cause the axle to break or otherwise fail. A pin joint assembly may be utilized to dampen such loads in order to prolong axle life. The pin joint assembly and associated components may be designed to enable easy removal of the pin joint assembly in order to ease maintenance and replacement.

U.S. Pat. No. 4,251,182 to Schroeder discloses a pivot pin assembly that includes an end plate. Bolts secure the end plate to a pin and a thrust ring of the pivot pin assembly. Additional bolts secure the end plate to a bracket. The bracket is affixed to a bucket configured for attachment to boom arms of a loader. The bolts ensure that the end plate, the pin, and the thrust ring do not rotate relative to the bracket. However, the bracket, the pin, the thrust ring, and the end plate rotate as a unit relative to bearings in the boom arms of the loader.

### SUMMARY

A pin joint assembly is disclosed that includes a pin, a collar configured to engage the pin, and a plate defining holes through which the plate may be fastened to the collar and to a frame of a machine on which the assembly is mounted.

A pin joint assembly is disclosed that includes a pin, a collar configured to engage the pin, and a plate defining first and second pluralities of plate bolt holes configured such that the plate may be fastened to a frame of a machine through the first plurality of plate bolt holes and the plate may be fastened to the collar through the second plurality of plate bolt holes. The machine further includes an axle assembly including an axle body and an axle tube substantially perpendicular to the axle body, the pin joint assembly being at least partially housed in the axle tube.

A pin joint assembly is disclosed that includes a pin, a collar configured to engage the pin, and a plate defining first and second pluralities of plate bolt holes configured such that the plate may be fastened to a frame of a machine through the first plurality of plate bolt holes and the plate may be fastened to the collar through the second plurality of plate bolt holes. The machine further includes an axle assembly including an axle body and an axle tube substantially perpendicular to the axle body, the pin joint assembly being at least partially housed in the axle tube. The pin joint assembly further includes first and second pluralities of bolts, wherein when the pin joint assembly is assembled, the first plurality of bolts is carried by the first plurality of plate bolt holes and the second plurality of bolts is carried by the second plurality of plate bolt holes, and the first plurality of bolts is substantially concentric with the second plurality of bolts.

### BRIEF DESCRIPTION OF THE DRAWINGS

FIG. 1 is a fragmentary perspective view of an axle assembly of a motor grader, including a pin joint assembly according to an embodiment of the invention;

FIG. 2 is a cross-sectional view taken through line 2--2 in FIG. 1; and

FIG. 3 is a detail view of a region encompassed by line 3 in FIG. 2.

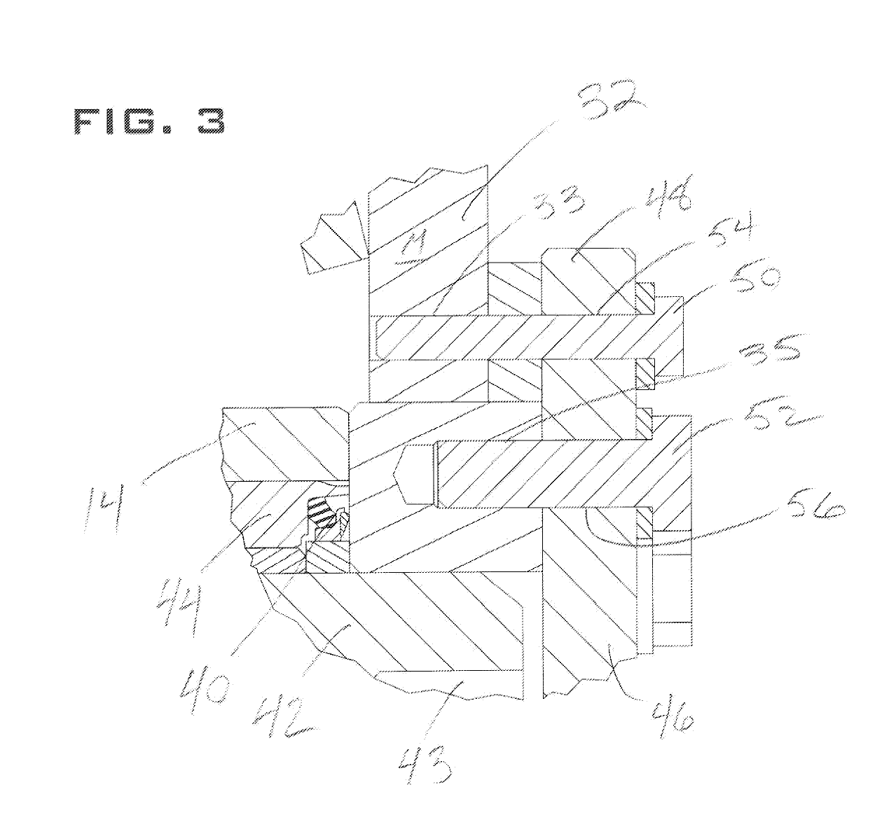

### DETAILED DESCRIPTION

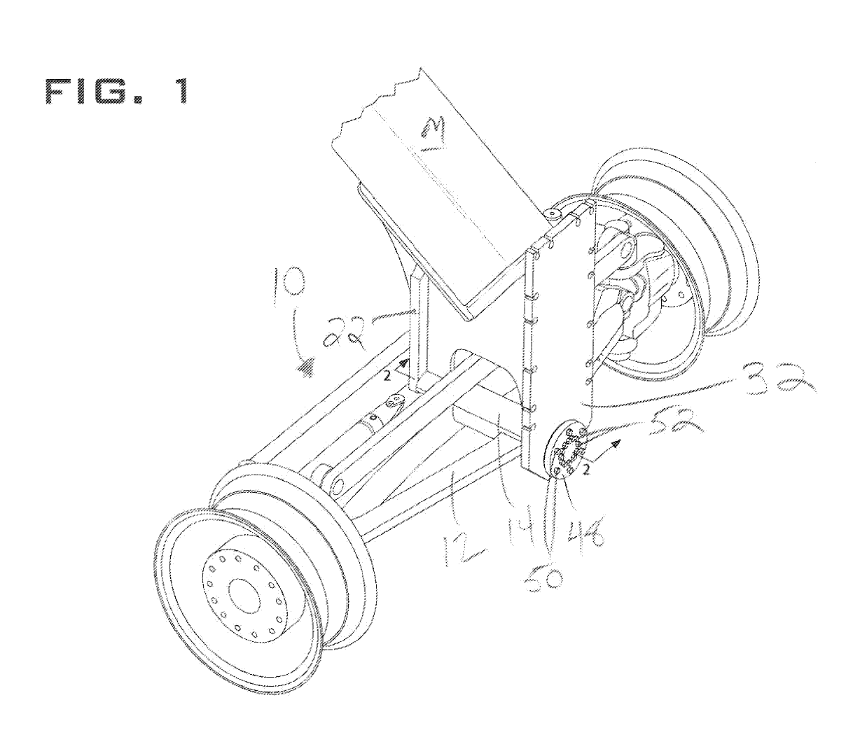

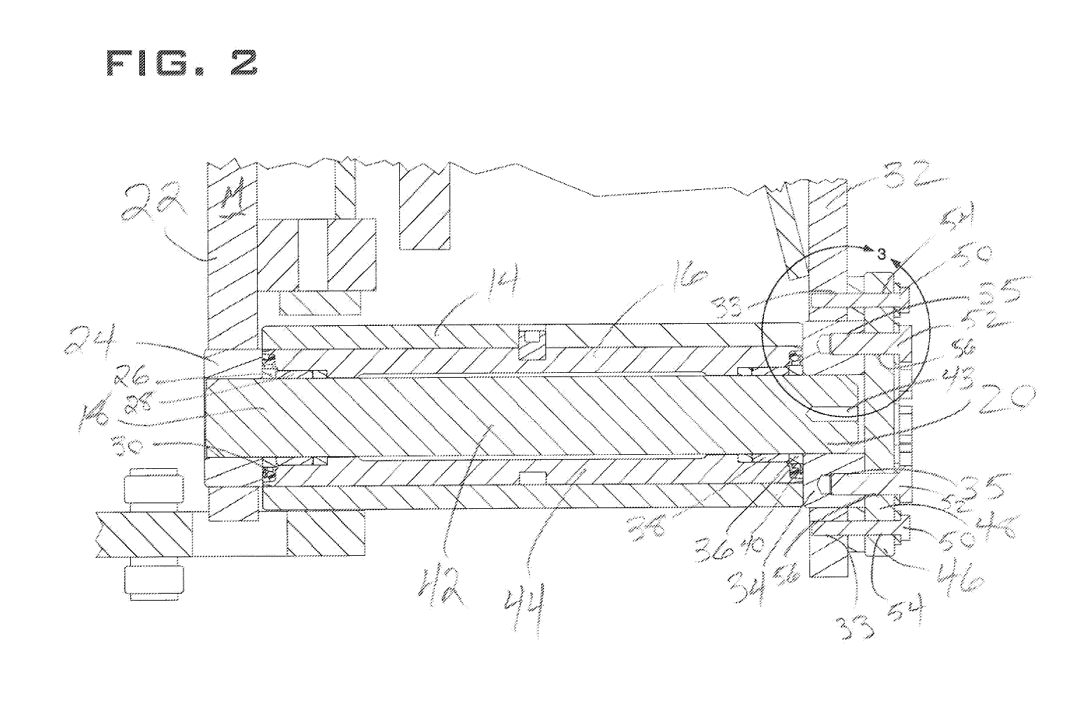

An axle assembly is shown broadly in FIG. 1 at reference numeral 10. The axle assembly 10 includes an axle body 12 engaging an axle tube 14, and a pin joint assembly 16 (FIG. 2) at least partially housed by the axle tube 14. The axle body 12 is substantially perpendicular to the axle tube 14. The pin joint assembly 16 includes first and second opposing end portions 18, 20. The first end portion 18 of the pin joint assembly 16 is engaged by a first frame plate 22 of a machine “M” and includes a first collar 24, a first thrust ring 26, a first sleeve bearing 28, and a first seal assembly 30. The second end portion 20 of the pin joint assembly 16 is engaged by a second frame plate 32 of the machine “M” and includes a second collar 34, a second thrust ring 36, a second sleeve bearing 38, and a second seal assembly 40. The second frame plate defines a plurality of frame bolt holes 33 and the second collar 34 defines a plurality of collar bolt holes 35. The pin joint assembly 16 also includes a pin 42 and a bushing 44. The pin 42 defines a pin puller hole 43.

The pin joint assembly 16 also includes a joint retention assembly 46. The joint retention assembly 46 includes a retaining plate 48 and first and second pluralities of bolts 50, 52. The retaining plate 48 defines first and second pluralities of plate bolt holes 54, 56 for receiving the first and second pluralities of bolts 50, 52, respectively. When the retaining plate 48 is installed, the first plurality of bolts 50 are carried by the first plurality of plate bolt holes 54 and the plurality of frame bolt holes 33, while the second plurality of bolts 52 are carried by the second plurality of plate bolt holes 56 and the plurality of collar bolt holes 35. When installed, the first plurality of bolts is substantially concentric with the second plurality of bolts.

### INDUSTRIAL APPLICABILITY

The illustrated axle assembly 10 is the front axle assembly of a motor grader. In the illustrated application, the pin joint assembly 16 enhances axle assembly compliance as the axle assembly 10 experiences lateral loads, radial loads, and other loads during motor grader operation, thereby helping to extend axle assembly life.

The joint retention assembly 46 of the pin joint assembly 16 eases maintenance and assembly. Specifically, when the retaining plate 48 is removed, a pin pulling tool (not shown) may be inserted into the pin puller hole 43 defined by the pin 42 and actuated to remove the pin 42 and associated components of the pin joint assembly 16.

A pin joint assembly is disclosed. Variations of the pin joint assembly of the invention may be practiced without departing from the scope of the invention, as the scope of the invention is set forth in the following claims.

What is claimed is:

1. A pin joint assembly, comprising:
a pin;
a collar configured to engage the pin;
a plate defining holes through which the plate may be fastened to the collar and to a frame of a machine on which the assembly is mounted.

2. The pin joint assembly of claim 1, wherein the machine includes an axle assembly comprising an axle tube and the pin joint assembly is at least partially housed in the axle tube.

3. The pin joint assembly of claim 2, wherein the axle assembly further comprises an axle body and the axle tube is substantially perpendicular to the axle body.

4. The pin joint assembly of claim 1, wherein the holes defined by the plate include first and second pluralities of plate bolt holes.

5. The pin joint assembly of claim 4, wherein the frame of the machine defines a plurality of frame bolt holes and the collar of the pin joint assembly defines a plurality of collar bolt holes.

6. The pin joint assembly of claim 5, wherein when the pin joint assembly is assembled, the first plurality of plate bolt holes are aligned with the frame bolt holes and the second plurality of plate bolt holes are aligned with the collar bolt holes.

7. The pin joint assembly of claim 6 further comprising first and second pluralities of bolts, wherein when the pin joint assembly is assembled, the first plurality of bolts is carried by the first plurality of plate bolt holes and the frame bolt holes, and the second plurality of bolts is carried by the second plurality of plate bolt holes and the collar bolt holes.

8. The pin joint assembly of claim 7, wherein the first plurality of bolts is substantially concentric with the second plurality of bolts.

9. The pin joint assembly of claim 1, wherein the plate is not bolted to the pin when the pin joint assembly is assembled.

10. A pin joint assembly, comprising:
a pin;
a collar configured to engage the pin;
a plate defining first and second pluralities of plate bolt holes configured such that the plate may be fastened to a frame of a machine through the first plurality of plate bolt holes and the plate may be fastened to the collar through the second plurality of plate bolt holes, the machine further comprising an axle assembly including an axle body and an axle tube substantially perpendicular to the axle body, the pin joint assembly being at least partially housed in the axle tube.

11. The pin joint assembly of claim 10, wherein the frame of the machine defines a plurality of frame bolt holes and the collar of the pin joint assembly defines a plurality of collar bolt holes.

12. The pin joint assembly of claim 11, wherein when the pin joint assembly is assembled, the first plurality of plate bolt holes are aligned with the frame bolt holes and the second plurality of plate bolt holes are aligned with the collar bolt holes.

13. The pin joint assembly of claim 12 further comprising first and second pluralities of bolts, wherein when the pin joint assembly is assembled, the first plurality of bolts is carried by the first plurality of plate bolt holes and the frame bolt holes, and the second plurality of bolts is carried by the second plurality of plate bolt holes and the collar bolt holes.

14. The pin joint assembly of claim 13, wherein the first plurality of bolts is substantially concentric with the second plurality of bolts.

15. The pin joint assembly of claim 10, wherein the plate is not bolted to the pin when the pin joint assembly is assembled.

16. A pin joint assembly, comprising:
a pin;
a collar configured to engage the pin;
a plate defining first and second pluralities of plate bolt holes configured such that the plate may be fastened to a frame of a machine through the first plurality of plate bolt holes and the plate may be fastened to the collar through the second plurality of plate bolt holes, the machine further comprising an axle assembly including an axle body and an axle tube substantially perpendicular to the axle body, the pin joint assembly being at least partially housed in the axle tube;
first and second pluralities of bolts, wherein when the pin joint assembly is assembled, the first plurality of bolts is carried by the first plurality of plate bolt holes and the second plurality of bolts is carried by the second plurality of plate bolt holes, and the first plurality of bolts is substantially concentric with the second plurality of bolts.

17. The pin joint assembly of claim 16, wherein the frame of the machine defines a plurality of frame bolt holes and the collar of the pin joint assembly defines a plurality of collar bolt holes.

18. The pin joint assembly of claim 17, wherein when the pin joint assembly is assembled, the first plurality of plate bolt holes are aligned with the frame bolt holes and the second plurality of plate bolt holes are aligned with the collar bolt holes.

19. The pin joint assembly of claim 18, wherein when the pin joint assembly is assembled, the first plurality of bolts is also carried by the frame bolt holes and the second plurality of bolts is also carried by the collar bolt holes.
